(19) United States
(12) Patent Application Publication
(10) Pub. No.: US 2006/0279508 A1
(43) Pub. Date: Dec. 14, 2006

(54) Apparatus to drive plasma display panel (PDP)

(76) Inventor: Kyoung-Doo Kang, Suwon-si (KR)

Correspondence Address: Robert E. Bushnell, Suite 300, 1522 K Street, N.W., Washington, DC, 20005-1202, US

(21) Appl. No.: 11/450,339

(22) Filed: Jun. 12, 2006

(30) Foreign Application Priority Data
Jun. 14, 2005 (KR) 10-2005-0051111

(51) Int. Cl. G09G 3/36

(52) U.S. Cl. 345/99

(57) ABSTRACT

An apparatus to drive a Plasma Display Panel (PDP) reduces heat by preventing a current generated by a sustain discharge from affecting a drive circuit. The apparatus is to drive a PDP including discharge cells and at least first and second electrodes. The apparatus includes: a display data signal supplier adapted to supply a display data signal to the second electrodes during an address period where a discharge cell of the discharge cells in which the discharge is to occur has been selected; and a switching unit adapted to switch to prevent a current generated by a sustain pulse supplied to the first electrodes from flowing through the display data signal supplier during a sustain period where the discharge occurs in the selected discharge cell.

### CLAIM OF PRIORITY

This application makes reference to, incorporates the same herein, and claims all benefits accruing under 35 U.S.C.§119 from an application for APPARATUS OF DRIVING PLASMA DISPLAY PANEL earlier filed in the Korean Intellectual Property Office on the 14^{th} of June 2005 and there duly assigned Serial No. 10-2005-0051111.

### BACKGROUND OF THE INVENTION

1. Field of the Invention

The present invention relates to an apparatus to drive a Plasma Display Panel (PDP), and more particularly, to an apparatus to drive a PDP that reduces heat by preventing current generated by a sustain discharge from affecting a drive circuit.

2. Description of the Related Art

A Plasma Display Panel (PDP) is a flat display having a wide screen, and displays a desired image by supplying a discharge voltage between two substrates having a plurality of electrodes to excite a patterned phosphor and to generate visible light.

An apparatus to drive a PDP supplies driving signals to a plurality of electrodes. To cause a discharge in a discharge cell partitioned by crossing the plurality of electrodes, the discharge cell to effect the discharge is first selected and a sustain discharge is induced in the selected discharge cell. Current generated by the sustain discharge flows through the electrodes in the apparatus to drive the PDP, and produces heat in the drive circuit of the apparatus used to drive the PDP. The drive circuit can be burned out due to current stress or voltage stress.

### SUMMARY OF THE INVENTION

The present invention provides an apparatus to drive a Plasma Display Panel (PDP) that reduces heat by preventing current generated by a sustain discharge from influencing a circuit device.

According to one aspect of the present invention, an apparatus to drive a PDP including a plurality of discharge cells and first and second electrodes is provided, the apparatus including: a display data signal supplier adapted to supply a display data signal to the second electrodes of the PDP during an address period where a discharge cell of the plurality of discharge cells in which a discharge is to occur has been selected; and a switching unit adapted to switch to prevent a current generated by a sustain pulse supplied to the first electrodes from flowing through the display data signal supplier during a sustain period where the discharge occurs in the selected discharge cell.

The switching unit is preferably connected between the display data signal supplier and the second electrodes. The switching unit preferably includes: a first switching device adapted to switch the current to flow to ground; and a second switching device adapted to switch to prevent the current from flowing to the display data signal supplier.

One end of the first switching device is preferably connected to ground, and another end of the first switching device is preferably connected to the second switching device and the second electrodes.

One end of the second switching device is preferably connected to the second electrodes and the first switching device, and another end of the second switching device is preferably connected to the display data signal supplier.

The first switching device is preferably adapted to be turned on and the second switching device is preferably adapted to be turned off during the sustain period. The first switching device is preferably adapted to be turned off and the second switching device is preferably adapted to be turned on during the address period.

The display data signal supplier preferably includes: a third switching device adapted to supply an address voltage to the second electrodes to select a discharge cell in which the discharge is to occur during the sustain period; and a fourth switching device adapted to supply the ground voltage to the second electrodes to select a discharge cell in which the discharge is not to occur during the sustain period.

One end of the third switching device is preferably connected to an address voltage, and another end of the third switching device is preferably connected to the fourth switching device and the second switching device.

One end of the fourth switching device is preferably connected to the third switching device and the second switching device, and another end of the fourth switching device is preferably connected to ground.

According to another aspect of the present invention, an apparatus to drive a Plasma Display Panel (PDP) including a plurality of discharge cells and first, second, and third electrodes is provided, the apparatus comprising: a display data signal supplier adapted to supply a display data signal to the third electrodes during an address period where a discharge cell of the plurality of discharge cells in which a discharge is to occur has been selected; and a switching unit adapted to switch to prevent a current generated by a sustain pulse alternately supplied to the first and second electrodes from flowing through the display data signal supplier during a sustain period where the discharge occurs in the selected discharge cell.

The switching unit preferably includes: a first switching device adapted to switch the current to flow to ground; and a second switching device adapted to switch to prevent the current from flowing to the display data signal supplier.

One end of the first switching device is preferably connected to ground, and another end of the first switching device is preferably connected to the second switching device and the third electrodes.

One end of the second switching device is preferably connected to the third electrodes and the first switching device, and another end of the second switching device is preferably connected to the display data signal supplier.

The first switching device is preferably adapted to be turned on and the second switching device is preferably adapted to be turned off during the sustain period. The first switching device is preferably adapted to be turned off and the second switching device is preferably adapted to be turned on during the address period.

The display data signal supplier preferably includes: a third switching device adapted to supply an address voltage to the third electrodes to select a discharge cell in which the discharge is to occur during the sustain period; and a fourth switching device adapted to supply the ground voltage to the third electrodes to select a discharge cell in which the discharge is not to occur during the sustain period.

One end of the third switching device is preferably connected to an address voltage, and another end of the third switching device is preferably connected to the fourth switching device and the second switching device.

One end of the fourth switching device is preferably connected to the third switching device and the second switching device, and another end of the fourth switching device is preferably connected to ground.

### BRIEF DESCRIPTION OF THE DRAWINGS

A more complete appreciation of the present invention and many of the attendant advantages thereof, will be readily apparent as the present invention becomes better understood by reference to the following detailed description when considered in conjunction with the accompanying drawings in which like reference symbols indicate the same or similar components, wherein:

FIG. 1 is a view of the arrangement of two electrodes of a Plasma Display Panel (PDP) according to an embodiment of the present invention;

FIG. 2 is a perspective view of the PDP having the electrode arrangement of FIG. 1;

FIG. 3 is a partially exploded perspective view of address electrodes and scan electrodes of the PDP of FIG. 2;

FIG. 4 is a block diagram of an apparatus to drive the PDP of FIG. 2;

FIG. 5 is a timing diagram of a method of driving the PDP of FIG. 2 by supplying an Address Display Separation (ADS) scheme to scan electrodes;

FIG. 6 is a timing diagram of a driving signal used to drive the PDP of FIG. 2;

FIG. 7 is a timing diagram of a current according to sustain pulses in a sustain period of FIG.6;

FIG. 8 is a circuit diagram of an apparatus to drive the PDP according to an embodiment of the present invention;

FIG. 9 is a schematic diagram of the arrangement of three electrodes of a PDP according to another embodiment of the present invention;

FIG. 10 is a perspective view of the PDP having the electrode arrangement of FIG. 9;

FIG. 11 is a block diagram of an apparatus to drive the PDP of FIG. 10;

FIG. 12 is a timing diagram of a driving signal used to drive the PDP of FIG. 10; and

FIG. 13 is a circuit diagram of an apparatus to drive the PDP according to another embodiment of the present invention.

### DETAILED DESCRIPTION OF THE INVENTION

The present invention is described more fully below with reference to the accompanying drawings, in which exemplary embodiments of the present invention are shown.

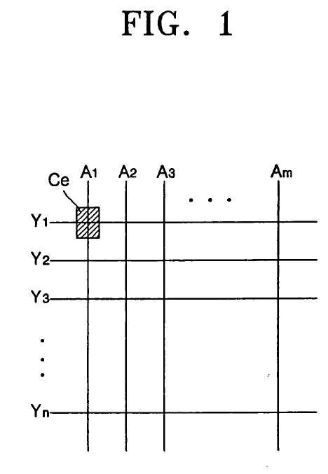

FIG. 1 is a view of the arrangement of two electrodes of a Plasma Display Panel (PDP) according to an embodiment of the present invention.

Referring to FIG. 1, a plurality of address electrodes A1 through Am are arranged from the top of the PDP to the bottom of the PDP, and a plurality of scan electrodes Y1 through Yn are arranged to cross the plurality of address electrodes A1 through Am. Discharge cells Ce are partitioned in the regions where the plurality of address electrodes A1 through Am and the plurality of scan electrodes Y1 through Yn cross each other. An image is displayed by a discharge generated in the discharge cells Ce.

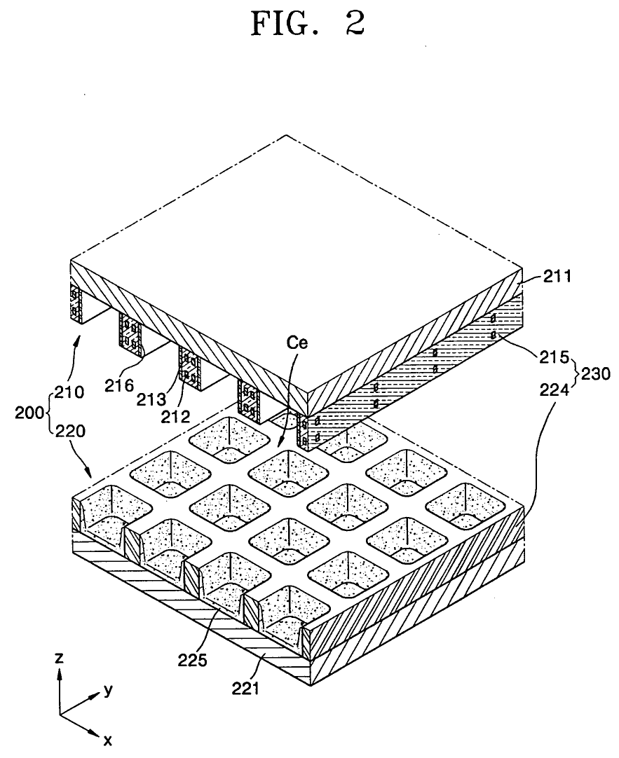

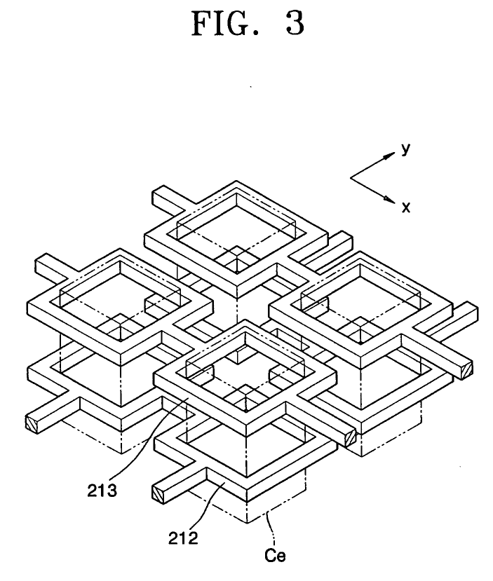

FIG. 2 is a perspective view of the PDP having the electrode arrangement of FIG. 1. FIG. 3 is a partially exploded perspective view of address electrodes and scan electrodes of the PDP of FIG. 2.

Referring to FIGS. 2 and 3, the PDP 200 includes a front panel 210 and a rear panel 220, and barrier ribs 230 that partition discharge cells Ce that generate the discharge and create light to realize an image on the PDP. The barrier ribs 230 can be formed by one body, or from front ribs 215 and rear ribs 224. The front panel 210 includes a transparent front substrate 211. The rear panel 220 includes a rear substrate 221 facing the front substrate 211 and parallel thereto.

The front panel 210 is formed at the rear (in a-Z direction) of the front substrate 211, and includes the front ribs 215 that partition discharge cells Ce. Also, the front panel 210 is located in the front ribs 215 to surround discharge cells Ce, and includes scan electrodes 212 and address electrodes 213 which are spaced from the front substrate 211 by a gap. The scan electrodes 212 and address electrodes 213 are spaced apart from each other and cross each other. If necessary, the front panel 210 includes a protection film 216 that covers the outside of the front ribs 215. The protection film 216 can be formed on the outside of the rear ribs 224 or the front of a phosphor layer 225, instead of on the outside of the front ribs 215.

The rear panel 220 is located at the front (in a Z direction) of the rear substrate 221, and includes the rear ribs 224 formed on the rear substrate 221, the phosphor layer 225 located in a space partitioned by the rear ribs 224, and a rear protection film (not shown) formed at the front of the phosphor layer 225 to cover the phosphor 225.

The front panel 210 and the rear panel 220 are sealed using a combination material such as frit (not shown). A discharge gas is injected into the discharge cells Ce, and can be composed of neon (Ne) including xenon (Xe) gas of approximately 10%, helium (He), argon (Ar), or a mixture of two or more of these gases.

The front panel 210 and the rear panel 220 are usually formed of glass. The front panel 210 can be formed of a material with a high optical transmittance. Visible light rays generated by the phosphor layer 225 of the discharge cells Ce transmit through the transparent front substrate 211 and have a front transmittance rate of more than 80%.

Barrier ribs 230 interposed between the front substrate 211 and the rear substrate 221 are formed to partition the discharge cells Ce. The barrier ribs 230 partition the discharge cells Ce onto a matrix as illustrated in FIG. 2. However, they are not restricted thereto, and can have a variety of patterns such as a waffle or a delta pattern, capable of forming a plurality of discharge spaces. Also, the cross-section of the discharge space can have the shape of a polygon such as a triangle, a pentagon, etc. or a circle, an oval, etc.

The scan electrodes 212 and the address electrodes 213 in the front ribs 215 surround the discharge cells Ce. The front ribs 215 prevent the scan electrodes 212 and the address electrodes 213 from directly supplying an electric current when discharged, prevent charged particles from colliding with and damaging the scan electrodes 212 and the address electrodes 213, and induce charged particles to form a dielectric layer capable of accumulating wall charges. The dielectric layer is formed of PbO, B2O3, SiO2, etc.

Since a voltage is supplied to the scan electrodes 212 and the address electrodes 213 to cause a discharge, the scan electrodes 212 and the address electrodes 213 can be composed of Ag, Cu, Cr, etc. with a high electrical conductivity.

The protection film 216 is composed of MgO or similar materials, and can be formed on the outside of the front ribs 215. The protection film 216 covers and protects the scan electrodes 212, the address electrodes 213, and the front ribs 215, and discharges secondary electrons such that the discharge can be easily effected.

The rear ribs 224 are formed on the rear substrate 221 and can be formed of a dielectric substance like the front ribs 215. The dielectric layer is formed of PbO, B2O3, SiO2, etc.

The rear ribs 224 form a space in which the phosphor layer 225 can be coated, support the pressure caused by a vacuum (e.g. 0.5 atm) of the discharge gas between the front panel 210 and the rear panel 220, and prevent crosstalk between the discharge cells Ce. The rear ribs 224 can include a reflection material to reflect the visible light rays generated in the discharge cells Ce to the front. The space partitioned by the rear ribs 224 can include a red light-emitting phosphor layer 225, a green light-emitting phosphor layer 225, or a blue light-emitting phosphor layer 225, partitioned by the rear ribs 224.

A phosphor paste containing a solvent, a binder, and either a red light-emitting phosphor, a green light-emitting phosphor, or a blue light-emitting phosphor is coated on the front (in the Z direction) of the rear substrate 221 and the outside of the rear ribs 224, and then drying and plasticity processing occurs to form the phosphor layer 225. The red light-emitting phosphor is Y(V,P)04:Eu, etc. the green light-emitting phosphor is ZnSiO4:Mn, YBO3:Tb, etc. and the blue light-emitting phosphor is ZnSiO4:Mn, YBO3:Tb, etc.

A rear protection film (not shown) composed of MgO or a similar material can be formed on the front (in the Z direction) of the phosphor layer 225. The rear protection film prevents deterioration of the phosphor layer 225 caused by the collision of discharge particles when a discharge occurs in the discharge cells Ce, and discharges secondary electrons to aid the discharge.

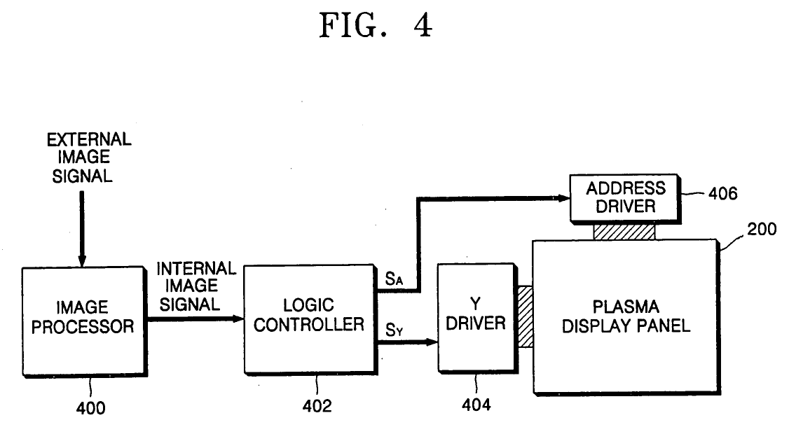

FIG. 4 is a block diagram of an apparatus to drive the PDP of FIG. 2.

The apparatus to drive the PDP includes an image processor 400, a logic controller 402, a Y driver 404, an address driver 406, and a PDP 200.

The image processor 400 converts an external image signal, such as a PC signal, a DVD signal, a video signal, a TV signal, etc. into a digital signal, image-processes the converted digital signal, and generates an internal image signal. The internal image signal includes red (R), green (G), and blue (B) image data, a clock signal, and vertical and horizontal synchronization signals.

The logic controller 402 receives the internal image signal from the image processor 400 and generates an address driver control signal SA and a Y driver control signal SY by processing a gamma correction and an Automatic Power Control (APC) for the internal image signal received from the image processor 400.

The Y driver 404 and the address driver 406 respectively receive the address driver control signal SA and the Y driver control signal SY from the logic controller 402, and supply them to a scan electrode and an address electrode of the PDP 200.

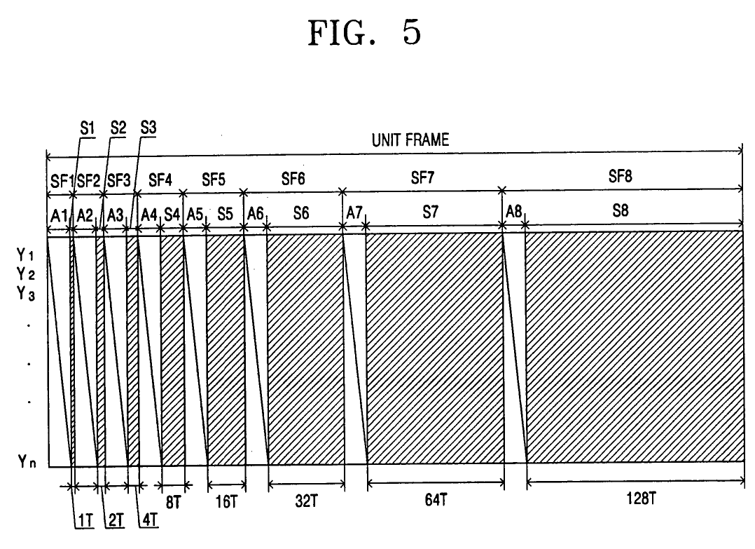

FIG. 5 is a timing diagram of a method of driving the PDP of FIG. 2 by supplying an Address Display Separation (ADS) scheme to scan electrodes.

Referring to FIG. 5, each unit frame having 60 Hz used to express an image is divided into a predetermined number, e.g. 8, of sub-fields SF1 through SF8 in order to achieve time-division gradation display. Also, each of the sub-fields SF1 through SF8 is respectively divided into a reset period (not shown), an address period A1 through A8, and a sustain discharge period S1 through S8.

In each of the address periods A1 through A8, display data signals are supplied to address electrodes and scan pulses supplied to scan electrodes Y1 through Yn are simultaneously supplied to effect an address discharge (addressing) that selects a discharge cell to be turned on.

In each of the sustain discharge periods S1 through S8, sustain pulses are alternately supplied to the scan electrodes Y1 through Yn to generate a sustain discharge in discharge cells in which wall charges are formed during the address periods A1 through A8.

The brightness of the PDP is proportional to the number of sustain pulses generated in the sustain discharge period S1 through S8 in a unit frame. For example, when the unit frame is divided into the eight sub-fields SF1 through SF8 and the brightness of the unit frame is divided into 256 gray-levels, sustain pulses are sequentially allocated to each of the eight sub-fields SF1 through SF8 at rates of 1, 2, 4, 8, 16, 32, 64, and 128. If the brightness of the 133rd gray-level is displayed, discharge cells are addressed at the first sub-field SF1, the third sub-field SF3, and the eighth sub-field SF8 to perform the sustain discharge. The number of the sustain discharge allocated to each of the eight sub-fields SF1 through SF8 is varied according to a weighting of the sub-fields of the APC scheme. The number of the sustain discharge can be determined based on gamma characteristics or panel characteristics. For example, a gradation allocated to the fourth sub-field SF4 can be reduced from 8 to 6 and a gradation allocated to the sixth sub-field SF6 can be increased from 32 to 34. Also, the number of sub-fields forming a frame can be varied based on the design of the PDP.

The driving signal generated by the apparatus to drive the PDP according to the present invention is not restricted to the ADS scheme, and can be supplied to all driving schemes used to supply a sustain pulse and to effect a sustain discharge.

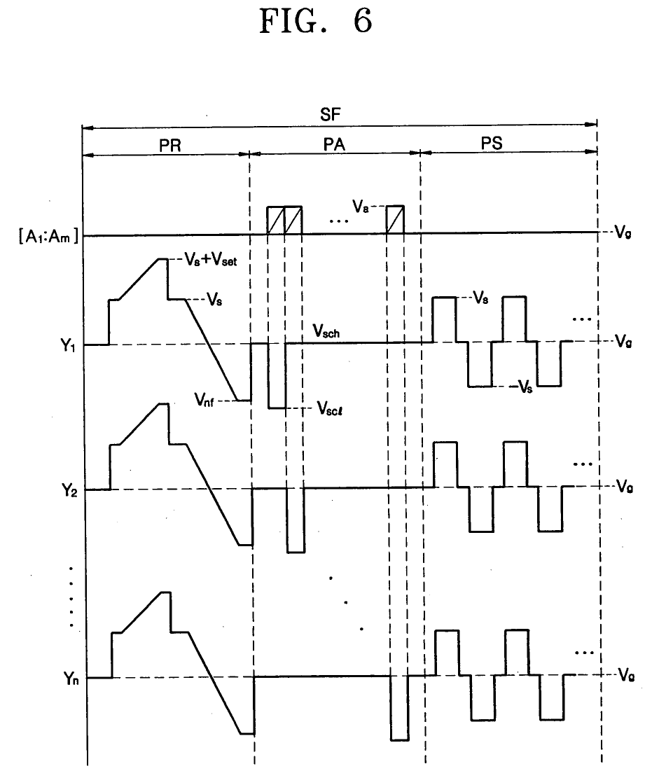

FIG. 6 is a timing diagram of a driving signal used to drive the PDP of FIG. 2.

Referring to FIG. 6, a sub-field SF is divided into a reset period PR, an address period PA, and a sustain period PS.

In the reset period PR, a reset discharge occurs to initialize discharge cells Ce that are partitioned by crossing scan electrodes Y1 through Yn and address electrodes A1 through Am as illustrated in FIG. 2. To this end, a reset pulse including a rising pulse and a falling pulse is supplied to the scan electrodes Y1 through Yn, and a ground voltage Vg is supplied to the address electrodes A1 through Am.

The rising pulse is increased by a second voltage Vset from a positive first voltage Vs to finally arrive at a third voltage Vset+Vs. The falling pulse is decreased from the positive first voltage Vs to finally arrive at a fourth voltage Vnf. The application of the rising pulse results in accumulating negative wall charges around the scan electrode in the discharge cell and positive wall charges around the address electrode in the discharge cell, and performing a weak discharge. The application of the falling pulse erases wall charges around the scan electrode and the address electrode and causes a weak discharge, such that a small quantity of negative wall charges are accumulated around the scan electrode and a small quantity of positive wall charges are accumulated around the address electrode, resulting in wall charges uniformly distributed throughout the all discharge cells at the end of the reset period PR.

In the address period PA, an address discharge is effected to select a discharge cell to be turned on. To this end, a scan pulse is supplied to the scan electrodes Y1 through Yn, and a display data signal is supplied to the address electrodes in accordance with the scan pulse.

The scan pulse sequentially attains a fifth voltage Vsch and then a sixth voltage Vscl lower than the fifth voltage Vsch. The display data signal has a positive seventh voltage Va in accordance with the scan pulse, more particularly the sixth voltage Vscl. If the fifth voltage Vsch and the sixth voltage Vscl are sequentially supplied to the scan electrode, and the seventh voltage Va is supplied to the address electrode of a discharge cell to be turned on, an address discharge (addressing) occurs between the scan electrode and the address electrode, positive wall charges are accumulated around the scan electrode, and negative wall charges are accumulated around the address electrode. A ground voltage is supplied to an address electrode of a discharge cell that is not selected as the discharge cell to be turned on, an address discharge 8 does not occur in the address electrode, negative wall charges are accumulated around a scan electrode of the non-selected discharge cell, and positive wall charges are accumulated around the address electrode.

In the sustain period PS, a sustain discharge occurs in a discharge cell which is selected to be turned on in the address period PA. To this end, a sustain pulse is supplied to the scan electrodes Y1 through Yn, and a ground voltage is supplied to the address electrodes A1 through Am.

The sustain pulse alternates between the positive first voltage Vs and a negative first voltage −Vs, and to prevent a rapid voltage change, can further include a ground voltage Vg which is an intermediate voltage between the positive first voltage Vs and the negative first 18 voltage −Vs.

If the sustain pulse having the positive first voltage Vs is supplied to the scan electrodes Y1 through Yn, positive wall charges are accumulated around a scan electrode and negative wall charges are accumulated around an address electrode in the discharge cell which is selected to be turned on in the address period PA, such that a sustain discharge occurs in the selected discharge cell to accumulate negative wall charges around the scan electrode and positive wall charges around the address electrode. Negative wall charges are accumulated around a scan electrode and positive wall charges are accumulated around an address electrode in a discharge cell which is not selected to be turned on in the address period PA, such that a sustain discharge does not occur in the non-selected discharge cell.

If the sustain pulse having the negative first voltage −Vs is supplied to the scan electrodes Y1 through Yn, a sustain discharge occurs to accumulate negative wall charges around a scan electrode and positive wall charges around an address electrode in a discharge cell, such that a sustain discharge occurs in the discharge cell to accumulate positive wall charges around the scan electrode and negative wall charges around the address electrode. Even if the sustain pulse having the negative first voltage −Vs is supplied in a discharge cell which is not selected to be turned on in the address period PA, a sustain discharge does not occur in the non-selected discharge cell.

The number of sustain pulses is determined according to a gradation weight of each of the eight sub-fields. The sustain discharge is continuously effected according to sustain pulses.

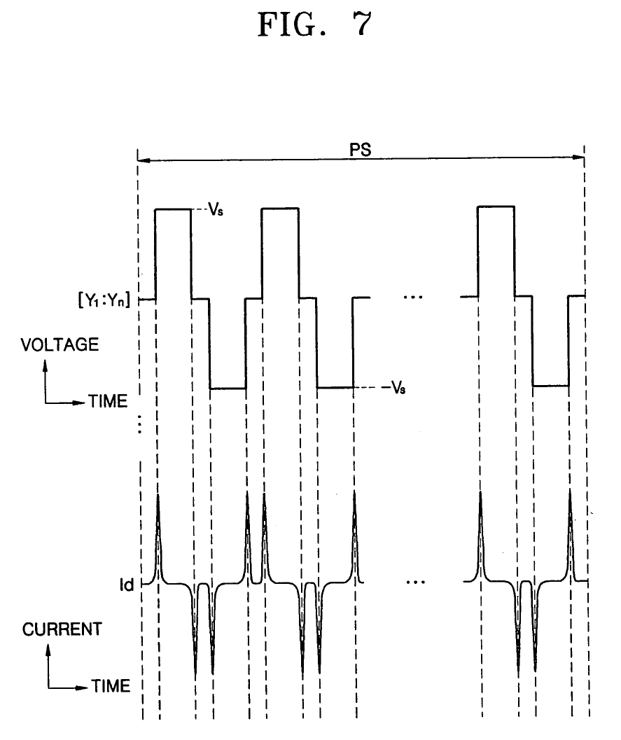

FIG. 7 is a timing diagram of a current according to sustain pulses in the sustain period of FIG. 6.

Referring to FIG. 7, when the sustain pulse alternating between the positive first voltage Vs and the negative first voltage −Vs is supplied to the scan electrodes Y1 through Yn, a current flows according to the changing voltage of the sustain pulse. The current flows at the time when a switching device is turned on to supply the positive first voltage Vs and the negative first voltage −Vs, and is called a displacement current. The displacement current is proportional to the rate of change of voltage. A positive displacement current flows when the ground voltage is changed to the positive first voltage Vs, and a negative displacement current flows when the ground voltage is changed to the negative first voltage −Vs.

When the application of the sustain pulse results in the sustain discharge in the discharge cell, a current is generated by the sustain discharge. The current is called a discharge current. The discharge current is generated when the sustain discharge occurs, i.e. when the sustain pulse is increased from the ground voltage to the positive first voltage Vs, and decreased from the ground voltage to the negative first voltage −Vs. The discharge current is significantly higher than the displacement current, and flows through a driving circuit.

The current Id of FIG. 7 is the sum of the displacement current and the discharge current. The current Id flows through the address driver via the scan electrode and the address electrode, which produces heat in a circuit device of the address driver, which can overload the circuit device. The switching device can be burnt out if the current Id is excessive.

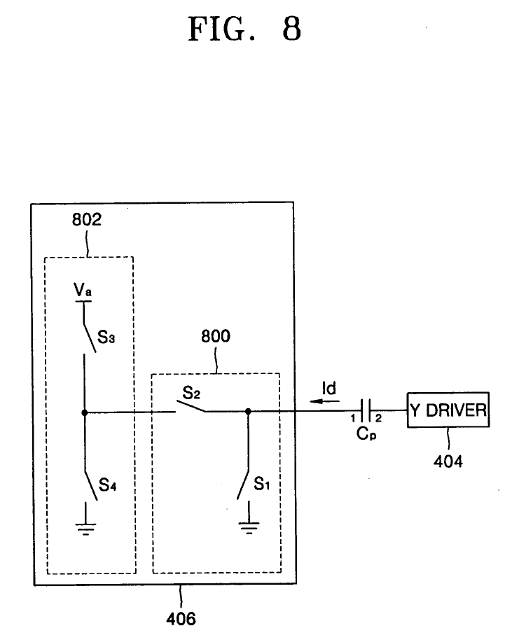

FIG. 8 is a circuit diagram of an apparatus to drive the PDP according to an embodiment of the present invention.

Referring to FIGS. 4, 5, 6, and 8, the apparatus includes a display data signal supplier 802 that supplies a display data signal to address electrodes in the address period PA where a discharge cell in which a discharge occurs is selected, and a switching unit 800 that prevents the current Id generated by a sustain pulse supplied to scan electrodes in the sustain period PS where the discharge occurs in the selected discharge cell from flowing to the display data signal supplier 802.

The address driver 406 is a constituent of the apparatus to drive the PDP and includes the display data signal supplier 802 that outputs a display data signal and the switching unit 800 that protects the display data signal supplier 802 from the current Id generated by the sustain pulse.

The switching unit 800 is connected between the display data signal supplier 802 and address electrodes (a first terminal of Cp) of the PDP, and includes a first switching device S1 that allows the current Id generated by the sustain pulse in the sustain period PS to flow to ground via the address electrodes (the first terminal of Cp), and a second switching device S2 that prevents the current Id from flowing to the display data signal supplier 802. One end of the first switching device S1 is connected to ground, and the other is connected to the second switching device S2 and the address electrodes (the first terminal of Cp). One end of the second switching device S2 is connected to the address electrodes (the first terminal of Cp) and the first switching device S1, and the other is connected to the display data signal supplier 802.

That is, the first switching device S1 is turned on and the second switching device S2 is turned off in the sustain period PS. Therefore, the current Id does not flow to the display data signal supplier 802 but to ground via the switching unit 800, which does not produce heat in circuit devices of the display data signal supplier 802, thereby preventing damage to the circuit devices. Instead, the first switching device S1 must stand the current stress of the current Id.

The display data signal supplier 802 outputs a display data signal and supplies the display data signal to the address electrodes (the first terminal of Cp) in the address period PA of FIG. 6. To this end, the display data signal supplier 802 includes a third switching device S3 that supplies an address voltage, i.e. a seventh voltage Va, to the address electrodes (the first terminal of Cp) to perform the discharge in the sustain period PS, and a fourth switching device S4 that supplies the ground voltage Vg to the address electrodes (the first terminal of Cp) to prevent discharge during the sustain period PS. In detail, one end of the third switching device S3 is connected to the address voltage, i.e. the seventh voltage Va, and the other is connected to the fourth switching device S4 and the second switching device S2. One end of the fourth switching device S4 is connected to the third switching device S3 and the second switching device S2, and the other is connected to ground.

The third switching device S3 is turned on and the fourth switching device S4 is turned off to allow the display data signal supplier 802 to select a discharge cell to be turned on in the address period PA. The third switching device S3 is turned off and the fourth switching device S4 is turned on to allow the display data signal supplier 802 to select a discharge cell not to be turned on in the address period PA of FIG. 6.

The scan electrodes (the second terminal of Cp) of the PDP are connected to the Y driver 404 of FIG. 8.

The address driver 406 can further include an energy recovery circuit (not shown) that collects and accumulates charges consumed in the PDP Cp by the application of the display data signal, or discharges the accumulated charge to the PDP Cp. The energy recovery circuit can include a capacitor, an inductor, and a switching device, and be connected to the display data signal supplier 802.

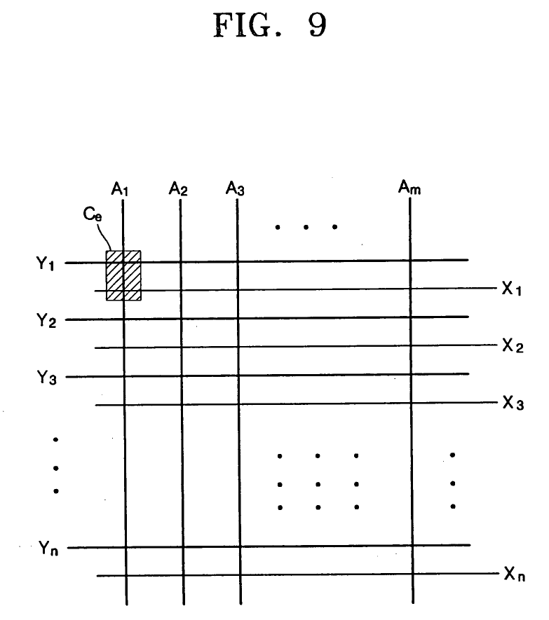

FIG. 9 is a schematic diagram of an arrangement of three electrodes of a PDP according to another embodiment of the present invention.

Referring to FIG. 9, the scan electrodes Y1 through Yn and the sustain electrodes X1 through Xn are parallel to each other, the address electrodes A1 through Am cross the scan electrodes Y1 through Yn and the sustain electrodes X1 through Xn. Discharge cells Ce are formed in the crossing regions.

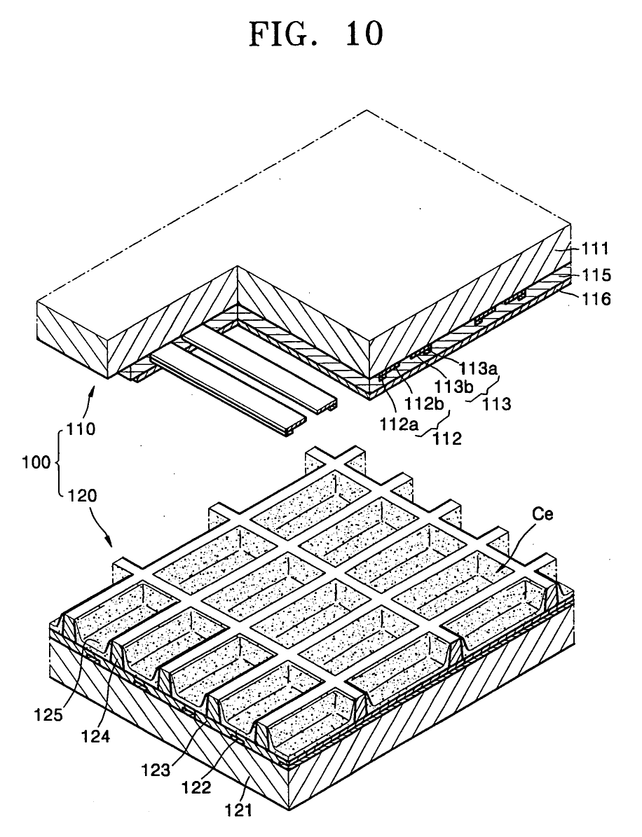

FIG. 10 is a perspective view of the PDP having the electrode arrangement of FIG. 9. Referring to FIG. 10, the PDP 100 includes a front panel 110 and a rear panel 120.

The front panel 110 includes a front substrate 111, a front dielectric layer 115, scan electrodes 112, sustain electrodes 113, and a front protection film 116.

The front dielectric layer 115 is located in the rear (in a −Z direction) of the front substrate 111 and covers the scan electrodes 112 and the sustain electrodes 113. The scan electrodes 112 and the sustain electrodes 113 includes bus electrodes 112a and 113a formed of a metallic material, and transparent electrodes 112b and 113b formed of a transparent conductive material such as Indium Tin Oxide (ITO) to increase conductivity, and extended parallel to each other. The front protection film 116 can be located in the rear (in a −Z direction) of the front dielectric layer 115 to protect the front dielectric layer 115.

The rear panel 120 includes a rear substrate 121, a rear dielectric layer 123, an address electrode 122, barrier ribs 124, and a phosphor layer 125.

The rear dielectric layer 123 is located in the front (in a Z direction) of the rear substrate 121 and covers the address electrodes 122. The address electrodes 122 cross the scan electrodes 112 and the sustain electrodes 113, and can be formed of Ag, Cu, Cr, etc. having a high electric conductivity without requiring optical transmittance. The barrier ribs 124 are located in the upper of the rear dielectric layer 13 to partition discharge cells. The phosphor layer 125 is located in a space partitioned by the barrier ribs 124. A rear protection film 128 is further located in the front of the phosphor 125. A discharge gas is injected into the discharge cells Ce, and can be composed of neon (Ne) including xenon (Xe) gas of approximately 10%, helium (He), argon (Ar), or a mixture of two or more of these gases.

The PDP is not restricted to the three electrode structure of FIG. 10.

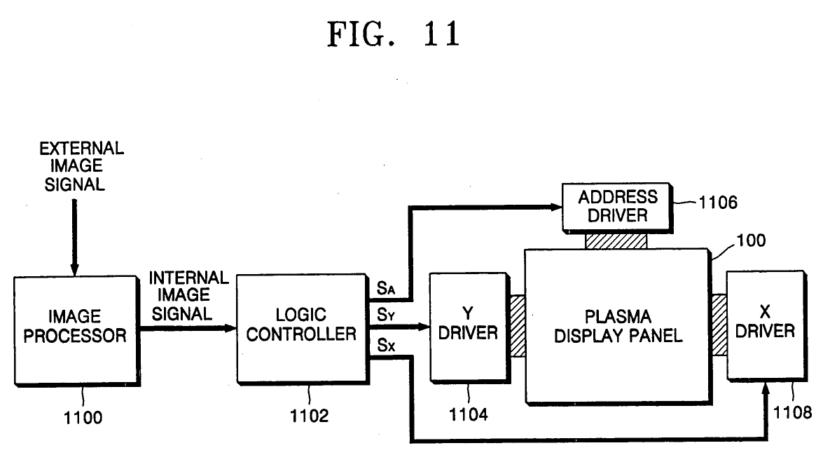

FIG. 11 is a block diagram of an apparatus to drive the PDP of FIG. 10. The apparatus to drive the PDP includes an image processor 1100, a logic controller 1102, a Y driver 1104, an address driver 1106, an X driver 1108, and a PDP 100.

The apparatus to drive the PDP having three electrodes of FIG. 11 is similar to the apparatus to drive the PDP having two electrodes of FIG. 4, but further includes the X driver 1104 to supply a driving signal to a sustain electrode. Therefore, the image processor 1100 receives an external image signal and outputs an internal image signal, the logic controller 1102 receives the internal image signal and respectively outputs a Y driving control signal SY, an address driving control signal SA, and an X driving control signal SX to the Y driver 1104, the address driver 1106, and the X driver 1108. The Y driver 1104, the address driver 1106, and the X driver 1108 respectively receive the Y driving control signal SY, the address driving control signal SA, and the X driving control signal SX from the logic controller 1102 and respectively supply the driving signal to a scan electrode, an address electrode, and a sustain electrode of the PDP 100.

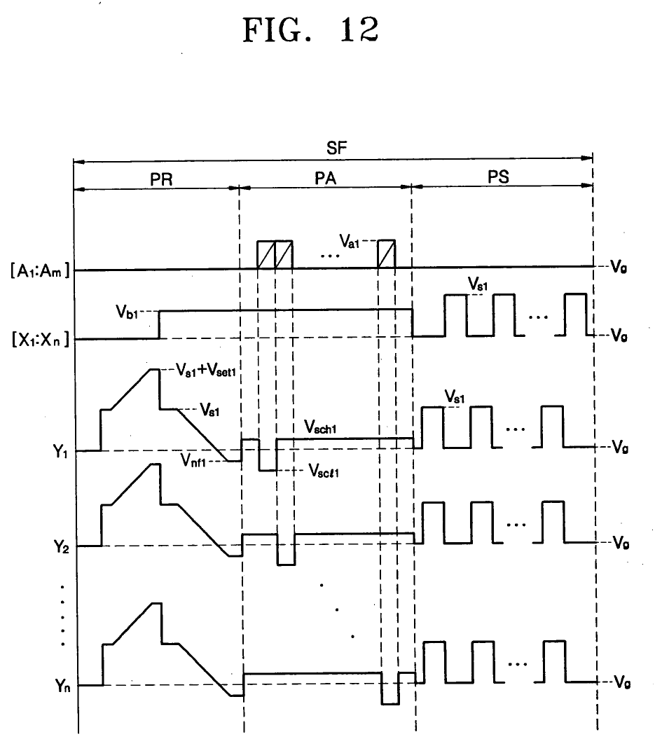

FIG. 12 is a timing diagram of a driving signal used to drive the PDP of FIG. 10. Referring to FIG. 12, in the reset period PR, a reset discharge occurs to initialize the discharge cells and to generate uniform wall charges. To this end, a reset pulse including a rising pulse and a falling pulse is supplied to the scan electrodes Y1 through Yn, a bias voltage is supplied to the sustain electrodes X1 through Xn from when the falling pulse is supplied, and the ground voltage Vg is supplied to the address electrodes A1 through Am. The rising pulse is increased by a second voltage Vsetl from a first voltage Vs1 and finally arrives at a third voltage Vsetl +Vs1. The falling pulse decreases from the first voltage Vs1 and finally arrives at a fourth voltage Vnf1. The application of the rising pulse accumulates negative wall charges around the scan electrode in the discharge cell and positive wall charges around the address electrode and the sustain electrode, and causes a weak discharge. The application of the falling pulse erases wall charges around the electrodes and causes a weak discharge such that positive wall charges are accumulated around the address electrode and negative wall charges are accumulated around the scan electrode and the address electrode at the end of the reset period PR.

In the address period PA, an address discharge occurs to select a discharge cell to be turned on. To this end, a scan pulse is supplied to the scan electrodes YI through Yn, a display data signal is supplied to the address electrodes in accordance with the scan pulse, and the bias voltage Vb is supplied to the sustain electrodes X1 through Xn. The scan pulse sequentially attains a fifth voltage Vsch1 and then a sixth voltage Vscl1 lower than the fifth voltage Vsch1. The display data signal attains a positive seventh voltage Val in accordance with the application of the sixth voltage Vscl1. An address discharge is caused between the scan electrodes and the address electrodes by the supplied scan pulse, display data signal, and bias voltage. At the end of the address period PA, positive wall charges are accumulated around the scan electrode, and negative wall charges are accumulated around the sustain electrode.

In the sustain period PS, a sustain discharge occurs in a discharge cell which is selected as the discharge cell to be turned on in the address period PA. To this end, a sustain pulse is alternately supplied to the sustain electrodes X1 through Xn and the scan electrodes Y1 through Yn, and the ground voltage is supplied to the address electrodes A1 through Am. The sustain pulse alternates between the first voltage Vs1 and the ground voltage Vg. The application of the sustain pulse results in positive wall charges and negative wall charges alternately accumulated around the scan electrode and the sustain electrode in the discharge cell which is selected as the discharge cell to be turned on in the address period PA, such that the sustain discharge is continuously performed.

The driving signal used to drive the PDP having three electrodes is not restricted to that of FIG. 12.

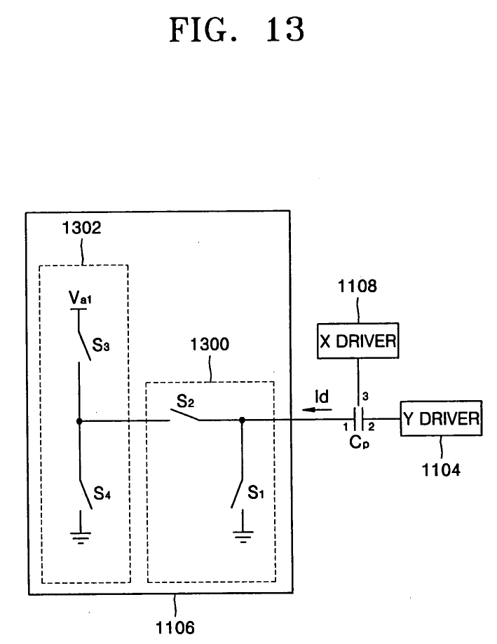

FIG. 13 is a circuit diagram of an apparatus to drive the PDP according to another embodiment of the present invention. Referring to FIGS. 11-13, the sustain pulse supplied to the scan electrodes and the sustain electrodes of FIG. 12 alternates between the positive first voltage Vs1 and the ground voltage Vg. A positive current flows when the sustain pulse is increased from the ground voltage Vg to the positive first voltage Vs1, and a negative current flows when the sustain pulse is decreased from the positive first voltage Vs1 to the ground voltage Vg. The apparatus to drive the PDP includes a display data signal supplier 1302 and a switching unit 1300 in order to prevent the current Id from influencing circuit devices of the apparatus to drive the PDP via the address electrode.

The display data signal supplier 1302 supplies a display data signal to the address electrodes in the address period PA. The display data signal supplier 1302 includes a third switching device S3 and a fourth switching device S4. One end of the third switching device S3 is connected to the address voltage Va1, and the other is connected to the fourth switching device S4 and the address electrodes (a first terminal of Cp) of the PDP. One end of the fourth switching device S4 is connected to the third switching device S3 and the address electrodes (a first terminal of Cp) of the PDP, and the other is connected to ground. The third switching device S3 is turned on and the fourth switching device S4 is turned off in order to supply a display data signal having an address voltage, i.e. the seventh voltage Val, to the address electrodes. The third switching device S3 is turned off and the fourth switching device S4 is turned on in order to supply a display data signal at the ground voltage to the address electrodes.

The switching unit 1300 is connected between the display data signal supplier 1302 and the address electrodes (the first terminal of Cp) of the PDP, and performs a switching operation to prevent the current Id generated by a sustain pulse in the sustain period PS from flowing through the display data signal supplier 1302 via address electrodes. To this end, the switching unit 1300 includes a first switching device S1 and a second switching device S2. One end of the first switching device S1 is connected to ground, and the other is connected to the second switching device S2 and the address electrodes (the first terminal of Cp). One end of the second switching device S2 is connected to the address electrodes (the first terminal of Cp) and the first switching device S1, and the other is connected to the display data signal supplier 1302. In the sustain period PS, the first switching device S1 is turned on to allow the current Id to flow to ground, and the second switching device S2 is turned off to prevent the current Id from flowing to the display data signal supplier 1302. The first switching device S1 is turned off and the second switching device S2 is turned on in order to supply the display data signal output by the display data signal supplier 1302 to the address electrodes (the first terminal of Cp) in the address period PA.

The Y driver 1104 is connected to scan electrodes (a second terminal of Cp) of the PDP, and the X driver 1108 is connected to sustain electrodes (a third terminal of Cp) of the PDP, as illustrated in FIG. 13.

The address driver 1106 can further include an energy recovery circuit (not shown) that collects and accumulates charge consumed in the PDP Cp by the application of the display data signal, or discharges the accumulated charge to the PDP Cp. The energy recovery circuit can include a capacitor, an inductor, and a switching device, and can be connected to the display data signal supplier 1302.

First, the apparatus to drive the PDP according to the present invention reduces heat produced by a current flowing through a circuit device of a display data signal supplier, since the current generated by a sustain pulse does not flow to the display data signal supplier via address electrodes.

Second, the circuit device is protected from overload, thereby protecting the display data signal supplier.

While the present invention has been particularly shown and described with reference to exemplary embodiments thereof, it will be understood by those of ordinary skill in the art that various modifications in form and detail can be made therein without departing from the spirit and scope of the present invention as defined by the following claims.

What is claimed is:

1. An apparatus to drive a Plasma Display Panel (PDP) including a plurality of discharge cells and first and second electrodes, the apparatus comprising:
a display data signal supplier adapted to supply a display data signal to the second electrodes of the PDP during an address period where a discharge cell of the plurality of discharge cells in which a discharge is to occur has been selected; and
a switching unit adapted to switch to prevent a current generated by a sustain pulse supplied to the first electrodes from flowing through the display data signal supplier during a sustain period where the discharge occurs in the selected discharge cell.

2. The apparatus of claim 1, wherein the switching unit is connected between the display data signal supplier and the second electrodes.

3. The apparatus of claim 2, wherein the switching unit comprises:
a first switching device adapted to switch the current to flow to ground; and
a second switching device adapted to switch to prevent the current from flowing to the display data signal supplier.

4. The apparatus of claim 3, wherein one end of the first switching device is connected to ground, and another end of the first switching device is connected to the second switching device and the second electrodes.

5. The apparatus of claim 4, wherein one end of the second switching device is connected to the second electrodes and the first switching device, and another end of the second switching device is connected to the display data signal supplier.

6. The apparatus of claim 5, wherein the first switching device is adapted to be turned on and the second switching device is adapted to be turned off during the sustain period.

7. The apparatus of claim 5, wherein the first switching device is adapted to be turned off and the second switching device is adapted to be turned on during the address period.

8. The apparatus of claim 7, wherein the display data signal supplier comprises:
a third switching device adapted to supply an address voltage to the second electrodes to select a discharge cell in which the discharge is to occur during the sustain period; and
a fourth switching device adapted to supply the ground voltage to the second electrodes to select a discharge cell in which the discharge is not to occur during the sustain period.

9. The apparatus of claim 8, wherein one end of the third switching device is connected to an address voltage, and another end of the third switching device is connected to the fourth switching device and the second switching device.

10. The apparatus of claim 9, wherein one end of the fourth switching device is connected to the third switching device and the second switching device, and another end of the fourth switching device is connected to ground.

11. An apparatus to drive a Plasma Display Panel (PDP) including a plurality of discharge cells and first, second, and third electrodes, the apparatus comprising:
a display data signal supplier adapted to supply a display data signal to the third electrodes during an address period where a discharge cell of the plurality of discharge cells in which a discharge is to occur has been selected; and
a switching unit adapted to switch to prevent a current generated by a sustain pulse alternately supplied to the first and second electrodes from flowing through the display data signal supplier during a sustain period where the discharge occurs in the selected discharge cell.

12. The apparatus of claim 11, wherein the switching unit comprises:
a first switching device adapted to switch the current to flow to ground; and
a second switching device adapted to switch to prevent the current from flowing to the display data signal supplier.

13. The apparatus of claim 12, wherein one end of the first switching device is connected to ground, and another end of the first switching device is connected to the second switching device and the third electrodes.

14. The apparatus of claim 13, wherein one end of the second switching device is connected to the third electrodes and the first switching device, and another end of the second switching device is connected to the display data signal supplier.

15. The apparatus of claim 14, wherein the first switching device is adapted to be turned on and the second switching device is adapted to be turned off during the sustain period.

16. The apparatus of claim 14, wherein the first switching device is adapted to be turned off and the second switching device is adapted to be turned on during the address period.

17. The apparatus of claim 16, wherein the display data signal supplier comprises:
a third switching device adapted to supply an address voltage to the third electrodes to select a discharge cell in which the discharge is to occur during the sustain period; and
a fourth switching device adapted to supply the ground voltage to the third electrodes to select a discharge cell in which the discharge is not to occur during the sustain period.

18. The apparatus of claim 17, wherein one end of the third switching device is connected to an address voltage, and another end of the third switching device is connected to the fourth switching device and the second switching device.

19. The apparatus of claim 18, wherein one end of the fourth switching device is connected to the third switching device and the second switching device, and another end of the fourth switching device is connected to ground.
